(19) United States
(12) Patent Application Publication
(10) Pub. No.: US 2015/0269889 A1
(43) Pub. Date: Sep. 24, 2015

(54) ORGANIC LIGHT-EMITTING DIODE DISPLAY DEVICE AND DRIVING METHOD THEREOF

(71) Applicant: InnoLux Corporation, Jhu-Nan (TW)

(72) Inventors: Hung-Lin HSU, Jhu-Nan (TW); Chun-Yu CHEN, Jhu-Nan (TW); Chien-Hsiang HUANG, Jhu-Nan (TW); Kung-Chen KUO, Jhu-Nan (TW); Ming-Chun TSENG, Jhu-Nan (TW)

(21) Appl. No.: 14/661,584

(22) Filed: Mar. 18, 2015

(30) Foreign Application Priority Data
Mar. 18, 2014 (TW) 103110147

(51) Int. Cl. G09G 3/32

(52) U.S. Cl. CPC G09G 3/3266; G09G 2320/0247; G09G 2320/0204; G09G 2310/0264

(57) ABSTRACT

An OLED display device and a driving method thereof are disclosed. The display device includes a display panel, m scan lines, n first control lines, n second control lines and a compensation driving circuit. The display panel includes a plurality of pixel units. Each of the pixel units has a compensation circuit. The pixel units are arranged into m rows, and pixel units of the rows are divided into n groups. The scan lines are disposed corresponding to and electrically connected with the pixel units of the rows. The first control lines and the second control lines are disposed corresponding to the groups and electrically connected with the pixel units of the corresponding groups. The ratio (m/n) is a positive integer, and 2≦(m/n)<m. The compensation driving circuit is electrically connected with the pixel units through the scan lines, the first control lines and the second control lines.

### CROSS REFERENCE TO RELATED APPLICATIONS

This Non-provisional application claims priority under 35 U.S.C. §119(a) on Patent Application No(s). 103110147 filed in Taiwan, Republic of China on Mar. 18, 2014, the entire contents of which are hereby incorporated by reference.

### BACKGROUND OF THE INVENTION

1. Field of Invention

The invention relates to a display device and driving method thereof and, in particular, to an organic light-emitting diode (OLED) display device and driving method thereof.

2. Related Art

Flat display apparatuses, having advantages such as low power consumption, less heat, light weight and non-radiation, are widely applied to various electronic products and gradually take the place of cathode ray tube (CRT) display apparatuses. A flat display apparatus can be divided into a passive matrix type and an active matrix type according to its driving method. Limited to the driving method, the passive matrix display apparatus is short of a long lifespan and unfavorable to a large-scale production. Although the active matrix display apparatus is made by an advanced technology with the higher cost, it is suitable for the large-scale and high-definition full color display with a large information capacity and therefore has become the mainstream of the flat display apparatus. For the active matrix display device, the matrix OLED display device is getting more and more popular recently.

However, due to some factors such as the variation of process, material or element characteristic, the threshold voltage (Vth) of the driving transistors applied to the active OLED display device for driving OLEDs may be shifted, and therefore the driving currents of the OLEDs of the pixels may be slightly different in magnitude even though the same data voltage is provided for driving. Consequently, the displayed image will have the problem of uneven brightness (such as Mura effect).

Accordingly, in the conventional art, a pixel compensation circuit is used to compensate the shift of the threshold voltage of the driving transistor to avoid the uneven brightness of the image. For the conventional pixel compensation, a so-called sequential compensation technique is to compensate the pixels of a row at one time according to the scanning sequence of the scan lines in the timing operation of the TFT circuit. However, this kind of compensation will increase the quantity of the signal circuit along the scanning direction and also the quantity of the driving IC (i.e. the gate driver).

For reducing the quantity of the above-mentioned signal circuit and driving IC, another compensation technique is proposed to connect the all signal circuits required for the compensation together to implement one-time compensation to all the pixels of the panel. However, such kind of one-time compensation will shorten the time for displaying image and lower down the average brightness of the displayed image, and besides, the displayed image will also easily have the flick issue.

Therefore, it is an important subject to provide an OLED display device and the driving method thereof which can reduce the quantity of the scanning signal circuit and driving IC and also can avoid the flick of the displayed image.

### SUMMARY OF THE INVENTION

In view of the foregoing subject, an objective of the invention is to provide an OLED display device and the driving method thereof which can reduce the quantity of scanning signal circuit and driving IC and also can avoid the flick of the displayed image.

To achieve the above objective, an OLED display device according to the invention includes a display panel, m scan lines, n first control lines, n second control lines and a compensation driving circuit. The display panel includes a plurality of pixel units arranged in a matrix formed by columns and rows. Each of the pixel units has a compensation circuit. The pixel units are arranged into m rows of the matrix, and pixel units of the rows are divided into n groups. The scan lines are disposed corresponding to and electrically connected with the pixel units of the rows. The first control lines and the second control lines are disposed corresponding to the groups and electrically connected with the pixel units of the corresponding groups. The ratio (m/n) is a positive integer, and 2≦(m/n)<m. The compensation driving circuit is electrically connected with the pixel units through the scan lines, the first control lines and the second control lines.

To achieve the above objective, a driving method of an OLED display device of the invention is disclosed. The OLED display device includes a display panel, m scan lines, n first control lines, n second control lines and a compensation driving circuit, the display panel includes a plurality of pixel units arranged in a matrix formed by columns and rows, each of the pixel units has a compensation circuit, and the compensation driving circuit is electrically connected with the pixel units through the scan lines, the first control lines and the second control lines. The driving method comprises a step of: driving the pixel units sequentially through the first control lines, the second control lines and the scan lines by the compensation driving circuit, wherein the pixel units are arranged into m rows of the matrix, the pixel units of the rows are divided into n groups, the scan lines are disposed corresponding to and electrically connected with the pixel units of the rows, the first control lines and the second control lines are disposed corresponding to the groups and electrically connected with the pixel units of the corresponding groups, and the ratio (m/n) is a positive integer and 2≦(m/n)<m.

As mentioned above, in the OLED display device and driving method thereof according to the invention, the pixel units are arranged into m rows, and pixel units of the rows are divided into n groups. Besides, the scan lines are disposed corresponding to and electrically connected with the pixel units of the rows. The first control lines and the second control lines are disposed corresponding to the groups and electrically connected with the pixel units of the corresponding groups. The ratio (m/n) is a positive integer, and 2≦(m/n)<m. Thereby, the OLED display device and the driving method thereof according to the invention not only can reduce the quantity of the scanning signal circuit and driving IC but also can avoid the flick of the displayed image.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic diagram of an OLED display device of an embodiment of the invention;

FIG. 1B is a schematic diagram of an OLED display device of an embodiment of the invention;

FIGS. 1C to 1F are schematic diagrams of different embodiments of the OLED display device in FIG. 1B;

FIG. 2 is a schematic diagram of an OLED display device of another embodiment of the invention;

FIG. 3 is a schematic flowchart of the driving method of the OLED display device of an embodiment of the invention;

FIG. 4A is a schematic diagram showing different stages of the pixel unit during a frame time in the conventional sequential compensation technique; and

FIG. 4B is a schematic diagram showing different stages of the group during a frame time in the driving method of the invention.

### DETAILED DESCRIPTION OF THE INVENTION

The present invention will be apparent from the following detailed description, which proceeds with reference to the accompanying drawings, wherein the same references relate to the same elements.

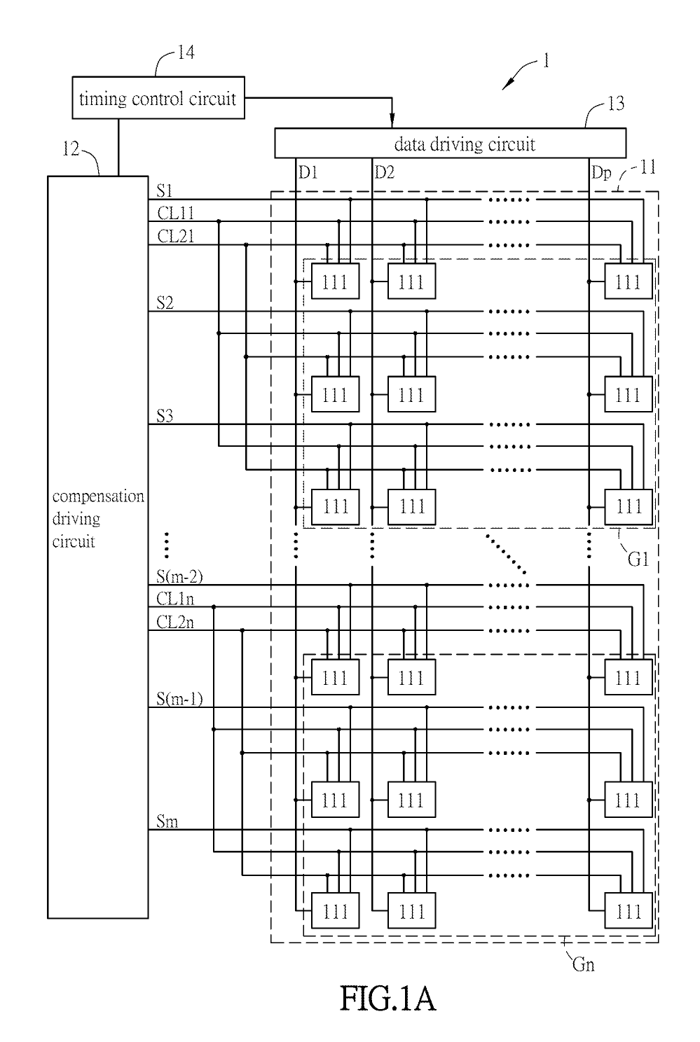

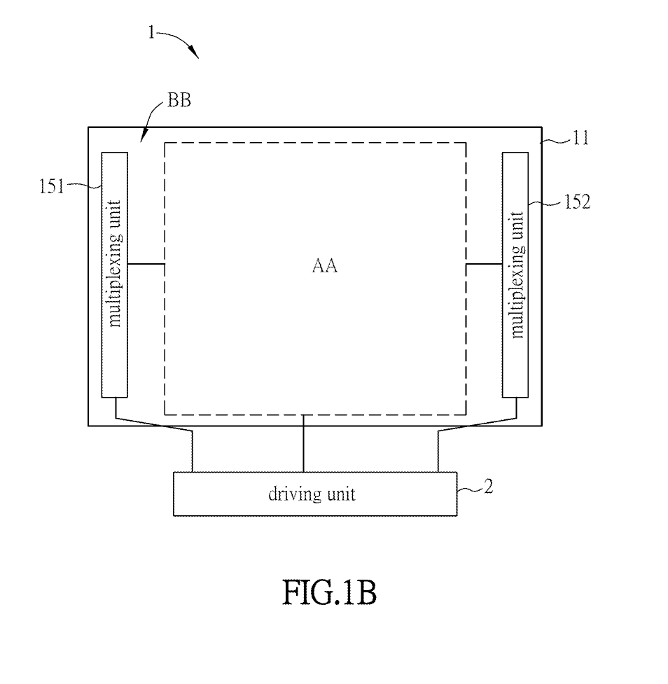

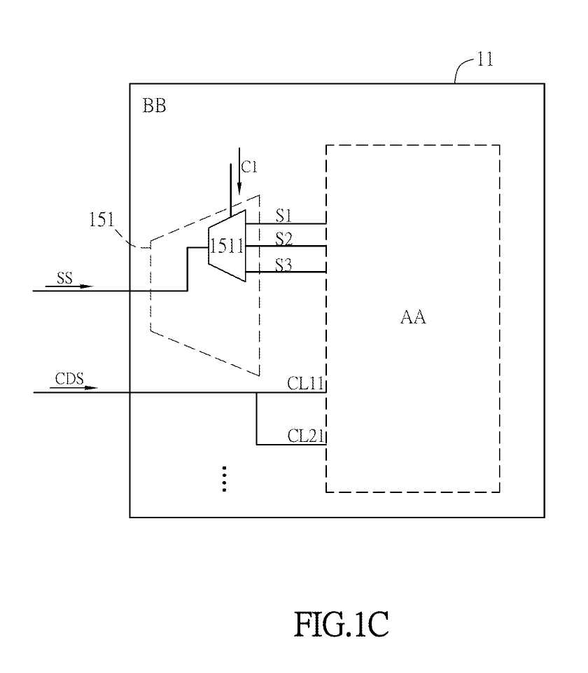

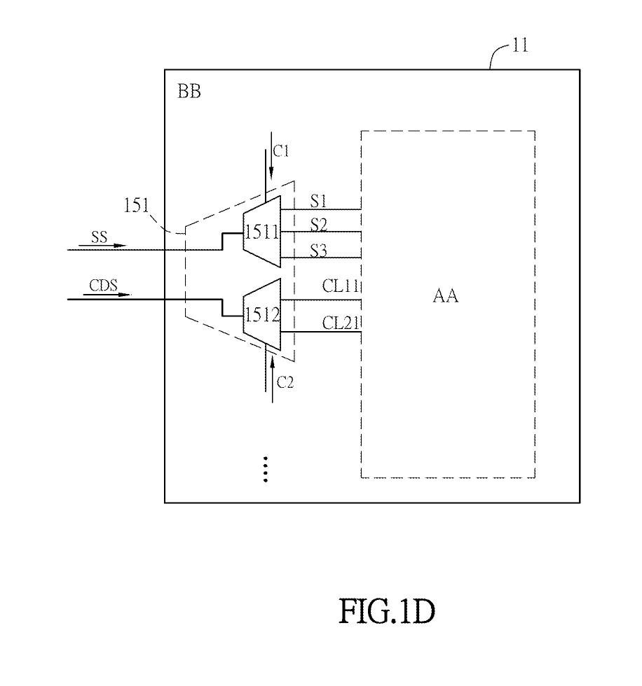

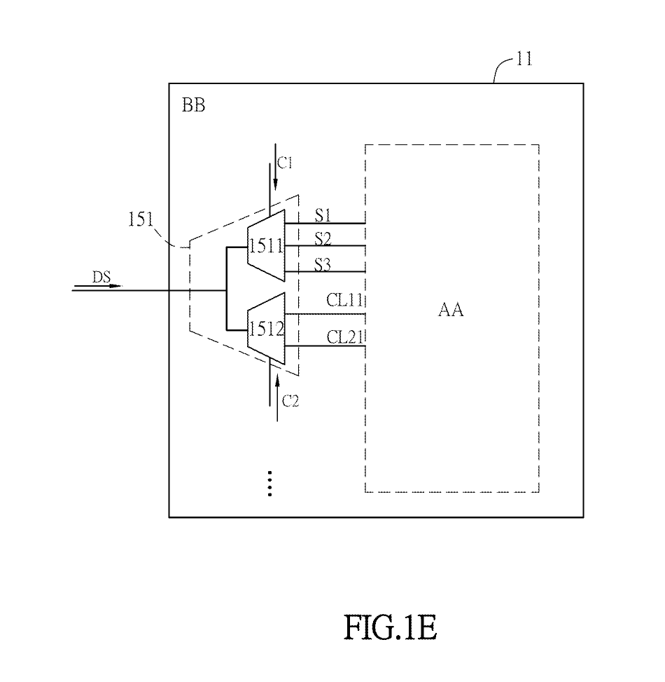

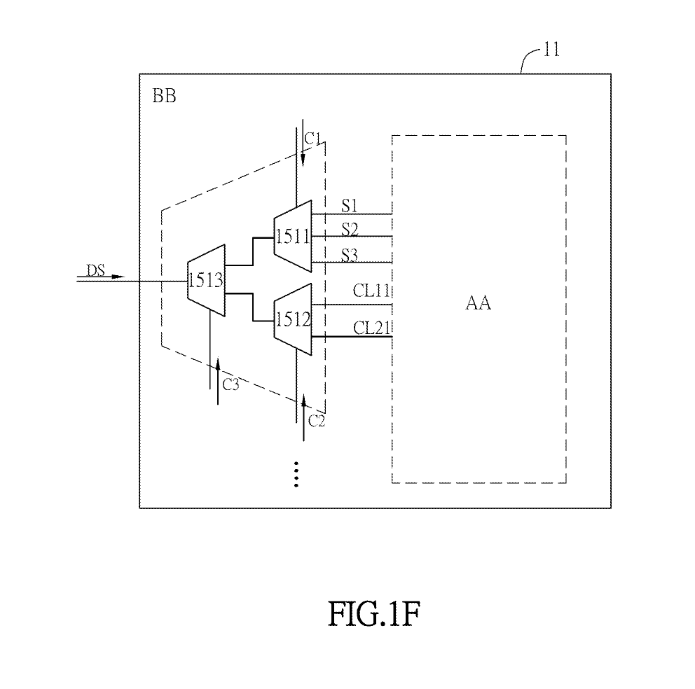

FIG. 1A is a schematic diagram of an OLED display device 1 of an embodiment of the invention.

As shown in FIG. 1A, the OLED display device 1 includes a display panel 11, m scan lines S1˜Sm, p data lines D1˜Dp, n first control lines CL11˜CL1n, n second control lines CL21˜CL2n and a compensation driving circuit 12. The ratio (m/n) is a positive integer, and 2≦(m/n)<m. Besides, the OLED display device 1 can further include a data driving circuit 13 and a timing control circuit 14.

The display panel 11 includes a plurality of pixel units 111, which are arranged in a matrix formed along a column direction and a row direction. For example, the above column direction is the vertical direction in FIG. 1A and the row direction is the horizontal direction in FIG. 1A. Moreover, each of the pixel unit 111 has a compensation circuit (not shown). The pixel unit 111 having the compensation circuit can implement the pixel compensation, and thereby the shift of the threshold voltage of the driving transistor of the OLED resulted from the factors such as the variation of process, material or element characteristic can be improved and the uneven brightness of the displayed image can be thus solved. The number and combination of the transistors and/or capacitors used in the pixel unit 111 are not limited in this invention. In different embodiments, the pixel unit 111 can be a 3T2C (three transistors and two capacitors) circuit, a 4T2C circuit or another kind of circuit with another number and combination of transistor and capacitor. Since the actual circuit structure of the pixel unit 111 and the mechanism of the compensation are not the main focus of this invention and can be comprehended by those skilled in the art, the related description is omitted here for conciseness.

There are m rows of the pixel units 111 and the pixel units 111 of the rows are divided into n groups G1˜Gn. Each of the groups has the same number of the rows and therefore has the same number of the pixel units 111. In other words, by regarding the row as a unit, the pixel units 111 of the all rows are divided averagely into n groups G1˜Gn along the column direction, so that each of the groups has the same number of the pixel units 111. Moreover, the compensation driving circuit 12 is electrically connected with the pixel units 111 of the display panel 11 through the scan liens S1˜Sm, the first control lines CL11˜CL1n and the second control lines CL21˜CL2n. In this embodiment, the pixel unit 111 is a 3T2C circuit structure for example, so the compensation driving circuit 12 is electrically connected with the all pixel units 111 of the same row through a scan line and electrically connected with the all pixel units 111 of the same group through a first control line (such as the compensation signal line) and a second control line (such as the signal line for controlling the lighting of the OLED). To be noted, the number of the control lines is not limited in this invention, and it may change according to the number of the elements used in the compensation driving circuit. Herein for example, there are two control line groups, indicating n first control lines CL11˜CL1n and n second control lines CL21˜CL2n.

The first control lines CL11˜CL1n and the second control lines CL21˜CL2n are disposed corresponding to the groups G1˜Gn and electrically connected with the pixel units 111 of the corresponding groups. In this embodiment, each of the groups has three rows of the pixel units 111 and therefore the number of the pixel units 111 of each group is 3*p (due to p columns). However, in other embodiments, each group can have the rows of a different quantity, and for example, 2 rows, 4 rows or others, so that the all pixel units 111 are divided into the groups of different numbers. The scan lines S1˜Sm are disposed corresponding to and electrically connected with the pixel units 111 of the rows. Herein as shown in FIG. 1A, the scan line S1 is electrically connected with the pixel units 111 of the first row, the scan line S2 is electrically connected with the pixel units 111 of the second row, . . . , and the scan line Sm is electrically connected with the pixel units of the m^{th} row. Accordingly, as an embodiment, there are totally m scan lines and m rows of the pixel units 111, and three rows of the pixel units 111 are specified as a group (there are totally n groups), so the ratio (m/n) is equal to 3.

The data driving circuit 13 is electrically connected with the pixel units 111 of the display panel 11 through the data lines D1˜Dp, and the timing control circuit 14 is electrically connected with the compensation driving circuit 12 and the data driving circuit 13. The timing control circuit 14 can transmit the vertical clock signal and the vertical synchronization signal to the compensation driving circuit 12, convert the image signal received through the external interface into the data signal used by the data driving circuit 13, and transmit the data signal, horizontal clock signal and horizontal synchronization signal to the data driving circuit 13. Besides, the compensation driving circuit 12 drives the pixel units 111 through the first control lines CL11˜CL1n, the second control lines CL21˜CL2n and the scan lines S1˜Sm sequentially. Herein, the compensation driving circuit 12 sequentially enables the scan lines S1˜Sm according to the vertical synchronization signal. Besides, before the compensation driving circuit 12, through a scan line, enables the pixel units 111 of the corresponding row, the compensation driving circuit 12 drives the pixel units 111 corresponding to the scan line through the first control lines CL11˜CL1n and the second control lines CL21˜CL2n to implement the pixel compensation and control the lighting of the OLED. The compensation driving circuit 12 implements the compensation to the shift of threshold voltage of TFT of the pixel units 111 through the first control lines CL11˜CL1n or the second control lines CL21˜CL2n. When the scan lines S1˜Sm are sequentially enabled, the data driving circuit 13 can transmit the pixel voltage signals corresponding to the pixel units 111 of each row to the corresponding pixel units 111 through the data lines D1˜Dp so that the display device 1 can display images.

FIG. 1B is a schematic diagram of the OLED display device 1 of an embodiment of the invention.

As shown in FIG. 1B, in practice, the compensation driving circuit 12, the data driving circuit 13 and the timing control circuit 14 can be integrated into a single driving unit 2 (also at least two of the compensation driving circuit 12, the data driving circuit 13 and the timing control circuit 14 may be integrated together). The driving unit 2 is, for example but not limited to, an IC, so as to drive and compensate the display panel 11. The display panel 11 has a display area AA and a peripheral area BB disposed on the outside of the display area AA, and the pixel units 111 (not shown) are disposed in the display area AA.

Moreover, the OLED display device 1 can further include at least one multiplexing unit disposed in the peripheral area BB. Herein for example, two multiplexing units 151, 152 are disposed on the opposite two sides of the peripheral area BB of the display panel 11, respectively (of course, only one multiplexing unit 151 can be used). The compensation driving circuit 12 of the driving unit 2 can be electrically connected with the scan lines S1˜Sm (not shown), the first control lines CL11˜CL1n (not shown), the second control lines CL21˜CL2n (not shown) and the pixel units 111 through the multiplexing units 151, 152.

FIGS. 1C to 1F are schematic diagrams of different embodiments of the OLED display device. Herein, only a part of the multiplexing unit 151 is shown in FIGS. 1C to 1F.

As shown in FIG. 1C, in this embodiment, the multiplexing unit 151 can include n first multiplexing elements 1511 which correspond to the n groups, and each of the first multiplexing elements 1511 is connected with the scan lines of the corresponding group (only a first multiplexing element 1511 is shown in FIG. 1C). One of the first multiplexing elements 1511 receives a scan signal SS and selectively outputs the scan signal SS to one of the scan lines connected with the first multiplexing element 1511 according to a first selection signal C1. After receiving the scan signal SS, the first multiplexing element 1511 of this embodiment selectively outputs the scan signal SS to one of the scan lines S1, S2, S3 connected with the first multiplexing element 1511 according to the first selection signal C1. In other words, by the first selection signal C1 controlling the first multiplexing element 1511, the scan signal SS outputted by the compensation driving circuit 12 (not shown) can sequentially enables the scan lines S1, S2, S3. Moreover, the compensation driving circuit 12 also can output a compensation driving signal CDS to the corresponding first control line CL11 and second control line CL21. Besides, before the compensation driving circuit 12, through the scan signal SS and some scan line (one of the scan lines S1, S2, S3) enables the pixel units 111 of the corresponding scan line, the compensation driving signal CDS can simultaneously drive the pixel units which are connected with the scan line through the corresponding first control line CL11 and second control line CL12, so as to do the operations of pixel compensation and OLED emission control.

As shown in FIG. 1D, the multiplexing unit 151 of this embodiment includes n first multiplexing elements 1511 and n second multiplexing elements 1512 which correspond to the n groups, wherein each of the first multiplexing elements 1511 is connected with the scan lines of the corresponding group and each of the second multiplexing elements 1512 is connected with the first control line and second control line of the corresponding group (only a first multiplexing element 1511 and a second multiplexing element 1512 are shown in FIG. 1D). One of the first multiplexing elements 1511 receives a scan signal SS and selectively outputs the scan signal SS to one of the scan lines connected with the first multiplexing element 1511 according to a first selection signal C1. Besides, when receiving the compensation driving signal CDS, the second multiplexing element 1512 selectively outputs the compensation driving signal CDS to one of the first control line and second control line connected with the second multiplexing element 1512 according to the second selection signal C2. After receiving the scan signal SS, the first multiplexing element 1511 of this embodiment selectively outputs the scan signal SS to one of the scan lines S1, S2, S3 connected with the first multiplexing element 1511 according to the first selection signal C1. After receiving the compensation driving signal CDS, the second multiplexing element 1512 of this embodiment selectively outputs the compensation driving signal CDS to one of the first control line CL11 and second control line CL12 connected with the second multiplexing element 1512 according to the second selection signal C2. Herein, the pixel units 111 connected with the first control line CL11 and the pixel units 111 connected with the second control line CL12 are given the operations of the pixel compensation and OLED emission control in a time-division manner. However, in other embodiments, the first control line CL11 and the second control line CL12 can be connected to each other (not shown) so that the compensation driving signal CDS can be simultaneously transmitted to the pixel units 111 connected with the first control line CL11 and the pixel units 111 connected with the second control line CL12.

As shown in FIG. 1E, the multiplexing unit 151 of this embodiment includes n first multiplexing elements 1511 and n second multiplexing elements 1512 which correspond to the n groups, wherein each of the first multiplexing elements 1511 is connected with the scan lines of the corresponding group and each of the second multiplexing elements 1512 is connected with the first control line and second control line of the corresponding group (only a first multiplexing element 1511 and a second multiplexing element 1512 are shown in FIG. 1E). One of the first multiplexing elements 1511 selectively outputs the driving signal DS to one of the scan lines connected with the first multiplexing element 1511 according to the first selection signal C1, or one of the second multiplexing elements 1512 selectively outputs the driving signal DS to one of the first control line and second control line connected with the second multiplexing element 1512 according to the second selection signal C2. The driving signal DS of this embodiment can include the scan signal SS and/or the compensation driving signal CDS, according to the driving purpose. If the driving signal DS is the scan signal SS, the second selection signal C2 controls the no output of the second multiplexing element 1512 and the first multiplexing element 1511, after receiving the scan signal SS, selectively outputs the scan signal SS to one of the scan lines S1, S2, S3 connected with the first multiplexing element 1511 according to the first selection signal C1. If the driving signal DS is the compensation driving signal CDS, the first selection signal C1 controls the no output of the first multiplexing element 1511 and the second multiplexing element 1512, after receiving the compensation driving signal CDS, selectively outputs the compensation driving signal CDS to one of the first control line CL11 and second control line CL12 connected with the second multiplexing element 1512 according to the second selection signal C2. Herein, the pixel units 111 connected with the first control line CL11 and the pixel units 111 connected with the second control line CL12 are given the operations of the pixel compensation and OLED emission control in a time-division manner. However, in other embodiments, the first control line CL11 and the second control line CL12 can be connected to each other (not shown) so that the compensation driving signal CDS can be simultaneously transmitted to the pixel units 111 connected with the first control line CL11 and the pixel units 111 connected with the second control line CL12.

As shown in FIG. 1F, in addition to the n first multiplexing elements 1511 and n second multiplexing elements 1512 which correspond to the n groups, the multiplexing unit 151 of this embodiment further includes n third multiplexing elements 1513 corresponding to the n groups. Each of the first multiplexing elements 1511 is connected with the scan lines of the corresponding group and each of the second multiplexing elements 1512 is connected with the first control line and second control line of the corresponding group. Besides, one of the third multiplexing elements 1513, after receiving the driving signal DS, selectively outputs the driving signal DS to the corresponding first multiplexing element 1511 or second multiplexing element 1512 through a third selection signal C3 (only a first multiplexing element 1511, a second multiplexing element 1512 and a third multiplexing element 1513 are shown in FIG. 1F). Like FIG. 1E, the driving signal DS of this embodiment can include the scan signal SS and/or the compensation driving signal CDS, according to the driving purpose. If the driving signal DS is the scan signal SS, the third selection signal C3 can control the third multiplexing element 1513 to output the scan signal SS to the first multiplexing element 1511 (the second selection signal C2 controls the no output of the second multiplexing element 1512), and the first multiplexing element 1511, after receiving the scan signal SS, selectively outputs the scan signal SS to one of the scan lines S1, S2, S3 connected with the first multiplexing element 1511 according to the first selection signal C1. If the driving signal DS is the compensation driving signal CDS, the third selection signal C3 controls the third multiplexing element 1513 to output the compensation driving signal CDS to the second multiplexing element 1512 (the first selection signal C1 controls the no output of the first multiplexing element 1511), and the second multiplexing element 1512, after receiving the compensation driving signal CDS, selectively outputs the compensation driving signal CDS to one of the first control line CL11 and second control line CL12 connected with the second multiplexing element 1512 according to the second selection signal C2. Herein, the pixel units 111 connected with the first control line CL11 and the pixel units 111 connected with the second control line CL12 are given the operations of the pixel compensation and OLED emission control in a time-division manner. However, in other embodiments, the first control line CL11 and the second control line CL12 can be connected to each other (not shown) so that the compensation driving signal CDS can be simultaneously transmitted to the pixel units 111 connected with the first control line CL11 and the pixel units 111 connected with the second control line CL12.

The above-mentioned first selection signal C1, second selection signal C2 and third selection signal C3 can be outputted by the timing control circuit 14 or the driving unit 2.

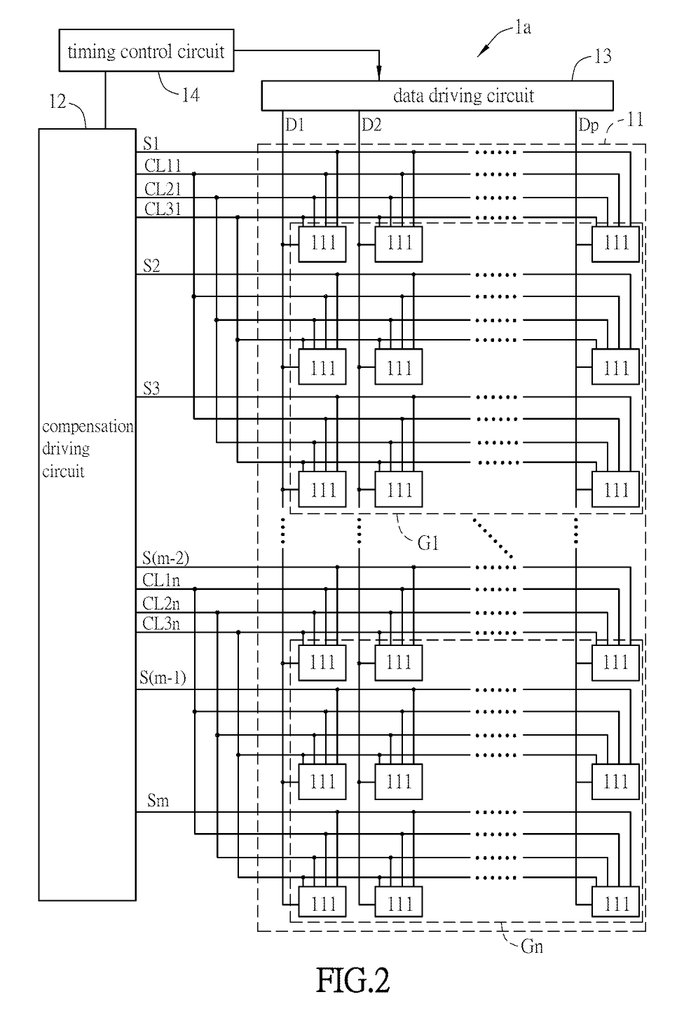

FIG. 2 is a schematic diagram of an OLED display device 1a of another embodiment of the invention.

The main difference from the OLED display device 1 is that the OLED display device 1a can further include n third control lines CL31˜CL3n, which are disposed corresponding to the groups G1˜Gn and electrically connected with the pixel units 111 of the corresponding groups G1˜Gn. Herein, the pixel unit 111 of the OLED display device 1a is a 4T2C circuit structure for example, so the compensation driving circuit 12 is electrically connected with the all pixel units 111 of the same row through a scan line and electrically connected with the all pixel units 111 of the same group through a first control line (such as the compensation signal line), a second control line (such as the signal line controlling the lighting switch of the OLED) and a third control line (such as a reset signal line).

The driving process and other technical features of the OLED display device 1 can be comprehended by referring to the OLED display device 1 and therefore the related descriptions are omitted here for conciseness.

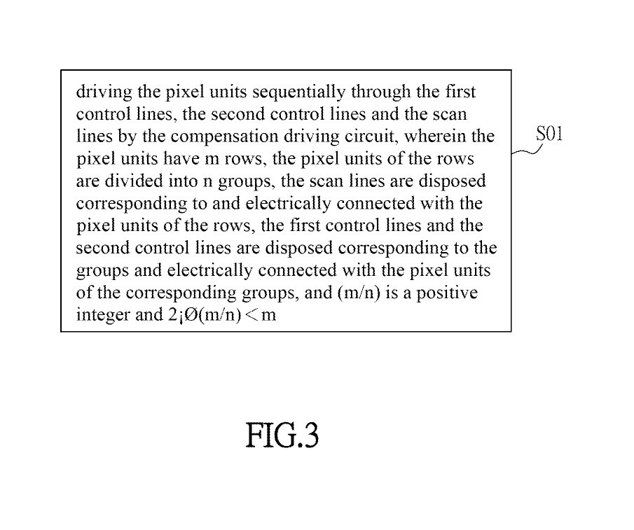

As below, refer to FIGS. 1A and 3 to illustrate the driving method of the OLED display device 1 of the invention. FIG. 3 is a schematic flowchart of the driving method of the OLED display device of an embodiment of the invention. Herein, since the technical features of the OLED display device 1 have been clearly illustrated in the above, the related description is omitted here for conciseness.

The driving method of the OLED display device 1 includes the step S01 of driving the pixel units 111 sequentially through the first control lines CL11˜CL1n, the second control lines CL21˜CL2n and the scan lines S1˜Sm by the compensation driving circuit 12, wherein the pixel units 111 are arranged into m rows, the pixel units 111 of the rows are divided into n groups G1˜Gn, the scan lines S1˜Sm are disposed corresponding to and electrically connected with the pixel units 111 of the rows, the first control lines CL11˜CL1n and the second control lines CL21˜CL2n are disposed corresponding to the groups G1˜Gn and electrically connected with the pixel units 111 of the corresponding groups G1˜Gn, and the ratio (m/n) is a positive integer and 2≦(m/n)<m.

Before the compensation driving circuit 12, through a scan line, enables the pixel units 111 of the corresponding row, the compensation driving circuit 12 implements the compensation to the shift of the threshold voltage of the TFTs of the pixel units 111 of the corresponding group through the first control lines CL11˜CL1n or the second control lines CL21˜CL2n. By taking the first scan line S1 as an example, before the scan line S1 enables the corresponding pixel units 111 of the first row, the compensation driving circuit 12 can implement the compensation to the shift of the threshold voltage of the TFTs of the all pixel units 111 of the first group G1 (three rows totally) through the first control line CL11 (or the second control line CL21). Then, before the scan line S2 enables the corresponding pixel units 111 of the second row, the compensation driving circuit 12 can implement the compensation to the shift of the threshold voltage of the TFTs of the all pixel units 111 of the second group G2 (three rows totally) through the first control line CL12 (or the second control line CL22). The rest can be deduced by analogy.

Furthermore, when the scan lines S1˜Sm are enabled sequentially, the data driving circuit 13 can transmit the pixel voltage signals corresponding to the pixel units 111 of each row to the corresponding pixel units 111 through the data lines D1˜Dp, and therefore the display device 1 can display images.

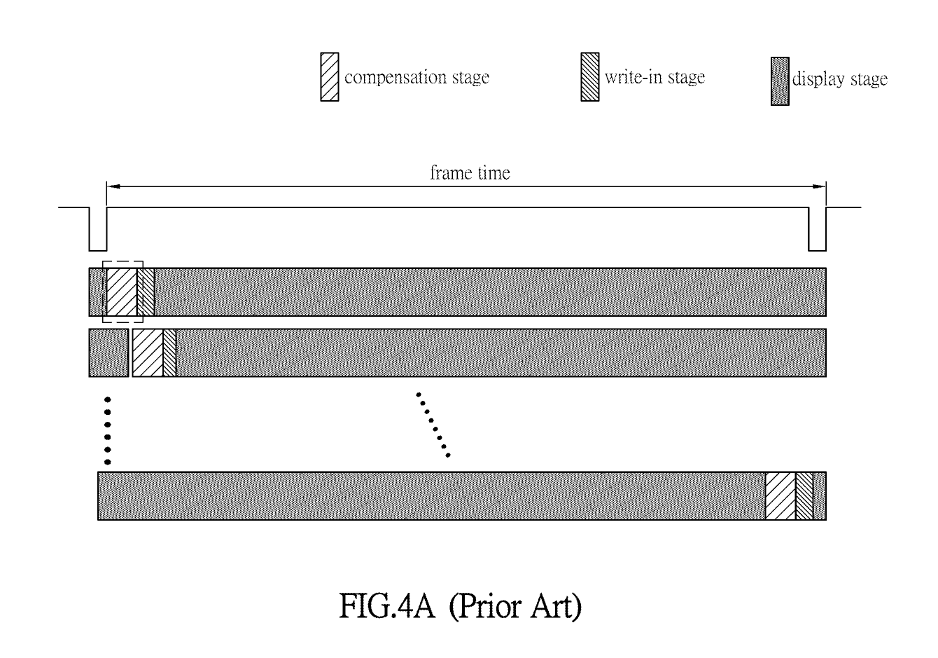

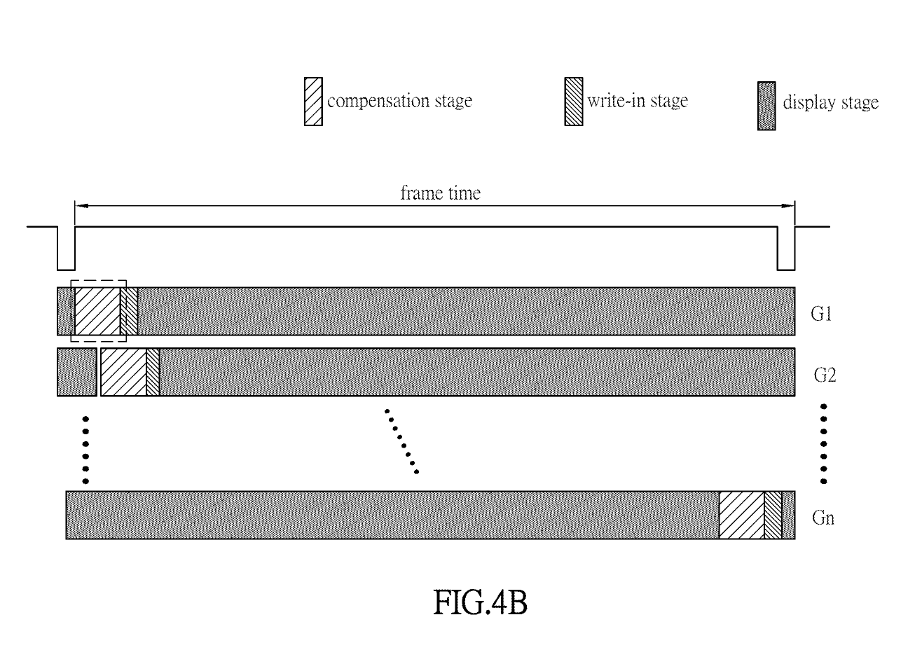

FIG. 4A is a schematic diagram showing different stages of the pixel unit during a frame time in the conventional sequential compensation technique, and FIG. 4B is a schematic diagram showing different stages of the group during a frame time in the driving method of the invention.

During a frame time, the pixel units 111 have three stages: a compensation stage, a write-in stage of pixel voltage and a display stage of image. By comparing FIG. 4A with FIG. 4B, it can be found that the compensation time of the pixel in the sequential scanning technique of FIG. 4A will be limited within the enabling time of a single scan line. By contrast, in the embodiment of FIG. 1A of the invention, the pixel units 111 are arranged into m rows, the pixel units 111 of the rows are divided into n groups G1˜Gn, the first control lines CL11˜CL1n and the second control lines CL21˜CL2n are disposed corresponding to the groups G1˜Gn and electrically connected with the pixel units of the corresponding groups. In other words, each of the first control lines and each of the second control lines are electrically connected with the pixel units 111 of a corresponding group (including three rows), and therefore the enabling time of a group, i.e. totally three scan lines, can be used for the pixel compensation. In comparison with the conventional sequential compensation technique, the compensation time of the invention, as shown in FIG. 4B, is longer than that of the sequential compensation. When the panel size is larger and the RC loading is thus greater, the more pixel compensation time can make the signal wave uneasily deform and therefore the display quality can be enhanced. Besides, thereby, the display device and driving method thereof in this embodiment also can reduce the quantity of the scan signal circuit (including scan lines, first control lines and second control liens) and further reduce the quantity of the driving IC of the compensation driving circuit 12. Additionally, the display time of FIG. 4B and the display time of the sequential compensation differ slightly, so the image flick issue of the one-time compensation technique will not occur. To be noted, when the compensation driving circuit 12 is integrated with the shift register (SR) circuit on the display panel 11 by the GOP (gate on panel) technology, the circuit complexity of the compensation driving circuit 12 can be further reduced.

By taking a physical embodiment as an example, when the OLED display device 1 has 480 scan liens (m=480), there are totally 160 groups (n=160) if a group has three rows (i.e. (m/n=3)), so the signal circuit for scanning, i.e. including the scan lines, first control lines and second control lines, just has 800 (i.e. 480+(480/3)+(480/3)) lines. However, for the sequential compensation, there will be 1440 (480 scan lines+480 first control lines+480 second control lines) lines of the scan signal circuit totally. Therefore, the invention can reduce the quantity of the signal circuit by 640 lines.

In other embodiments, if 4 rows are a group (i.e. (m/n)=4), there will be 120 groups (n=120), and therefore this invention only has 720 (480+(480/4)+(480/4)) lines for the scan signal circuit, less than the sequential compensation by 720 lines.

Furthermore, for the structure of the OLED display device 1a in FIG. 2, the third control lines CL31˜CL3n are disposed corresponding to the groups G1˜Gn and electrically connected with the pixel units 111 of the corresponding groups G1˜Gn. Therefore, before the compensation driving circuit 12, through a scan line, enables the pixel units 111 of the corresponding row, the driving method can further include a step of driving the corresponding pixel units 111 through the third control lines by the compensation driving circuit 12.

Since other technical features of the driving method of the OLED display device have been clearly illustrated in the above, the related description is omitted here for conciseness.

Summarily, in the OLED display device and driving method thereof according to the invention, the pixel units are arranged into m rows, and pixel units of the rows are divided into n groups. Besides, the scan lines are disposed corresponding to and electrically connected with the pixel units of the rows. The first control lines and the second control lines are disposed corresponding to the groups and electrically connected with the pixel units of the corresponding groups. The ratio (m/n) is a positive integer, and 2≦(m/n)<m. Thereby, the OLED display device and the driving method thereof according to the invention not only can reduce the quantity of the scanning signal circuit and driving IC but also can avoid the flick of the displayed image.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. An OLED display device, comprising:
a display panel including a plurality of pixel units arranged in a matrix formed by columns and rows, wherein each of the pixel units has a compensation circuit, the pixel units are arranged into m rows of the matrix, and the pixel units of the rows are divided into n groups;
m scan lines disposed corresponding to and electrically connected with the pixel units of the rows;
n first control lines and n second control lines disposed corresponding to the groups and electrically connected with the pixel units of the corresponding groups, wherein the ratio (m/n) is a positive integer, and 2≦(m/n)<m; and
a compensation driving circuit electrically connected with the pixel units through the scan lines, the first control lines and the second control lines.

2. The OLED display device as recited in claim 1, wherein each of the groups has the pixel units of the same number of the rows.

3. The OLED display device as recited in claim 1, wherein the compensation driving circuit drives the pixel units through the first control lines, the second control lines and the scan lines sequentially.

4. The OLED display device as recited in claim 1, wherein the compensation driving circuit, through a first control line and a second control line, is electrically connected with the all pixel units of the corresponding group.

5. The OLED display device as recited in claim 1, further comprising:
n third control lines, which are disposed corresponding to the groups and electrically connected with the pixel units of the corresponding groups.

6. The OLED display device as recited in claim 1, further comprising:
at least one multiplexing unit, wherein the display panel has a display area and a peripheral area disposed on the outside of the display area, the multiplexing unit is disposed in the peripheral area, and the compensation driving circuit is electrically connected with the scan lines, the first control lines, the second control lines and the pixel units through the multiplexing unit.

7. The OLED display device as recited in claim 1, further comprising:
at least one multiplexing unit including n first multiplexing elements which correspond to the n groups, wherein each of the first multiplexing elements is connected with the scan lines of the corresponding group, and one of the first multiplexing elements receives a scan signal and selectively outputs the scan signal to one of the scan lines connected with the first multiplexing element according to a first selection signal.

8. The OLED display device as recited in claim 1, further comprising:
at least one multiplexing unit including n first multiplexing elements and n second multiplexing elements which correspond to the n groups, wherein each of the first multiplexing elements is connected with the scan lines of the corresponding group, each of the second multiplexing elements is connected with the first control line and second control line of the corresponding group, one of the first multiplexing elements receives a scan signal and selectively outputs the scan signal to one of the scan lines connected with the first multiplexing element according to a first selection signal, and one of the second multiplexing elements receives a compensation driving signal and selectively outputs the compensation driving signal to one of the first control line and second control line connected with the second multiplexing element according to a second selection signal.

9. The OLED display device as recited in claim 1, further comprising:
at least one multiplexing unit including n first multiplexing elements and n second multiplexing elements which correspond to the n groups, wherein each of the first multiplexing elements is connected with the scan lines of the corresponding group, each of the second multiplexing elements is connected with the first control line and second control line of the corresponding group, one of the first multiplexing elements selectively outputs a driving signal to one of the scan lines connected with the first multiplexing element according to a first selection signal, or one of the second multiplexing elements selectively outputs the driving signal to one of the first control line and second control line connected with the second multiplexing element according to a second selection signal.

10. The OLED display device as recited in claim 6, further comprising:
at least one multiplexing unit including n first multiplexing elements, n second multiplexing elements and n third multiplexing elements which correspond to the n groups, wherein each of the first multiplexing elements is connected with the scan lines of the corresponding group, each of the second multiplexing elements is connected with the first control line and second control line of the corresponding group, each of the third multiplexing elements is connected with the corresponding first multiplexing element and second multiplexing element, one of the first multiplexing elements selectively outputs a driving signal to one of the scan lines connected with the first multiplexing element according to a first selection signal, or one of the second multiplexing elements selectively outputs the driving signal to one of the first control line and second control line connected with the second multiplexing element according to a second selection signal, and one of the third multiplexing elements selectively outputs the driving signal to the corresponding first multiplexing element or second multiplexing element through a third selection signal.

11. A driving method of an OLED display device, wherein the OLED display device includes a display panel, m scan lines, n first control lines, n second control lines and a compensation driving circuit, the display panel includes a plurality of pixel units arranged in a matrix formed by columns and rows, each of the pixel units has a compensation circuit, and the compensation driving circuit is electrically connected with the pixel units through the scan lines, the first control lines and the second control lines, the driving method comprising a step of:
driving the pixel units sequentially through the first control lines, the second control lines and the scan lines by the compensation driving circuit, wherein the pixel units are arranged into m rows of the matrix, the pixel units of the rows are divided into n groups, the scan lines are disposed corresponding to and electrically connected with the pixel units of the rows, the first control lines and the second control lines are disposed corresponding to the groups and electrically connected with the pixel units of the corresponding groups, and the ratio (m/n) is a positive integer and 2≦(m/n)<m.

12. The driving method as recited in claim 11, wherein each of the groups has the pixel units of the same number of the rows.

13. The driving method as recited in claim 11, wherein before the compensation driving circuit, through one of the scan lines, enables the pixel units of the corresponding row, the compensation driving circuit implements the compensation to the shift of threshold voltage of TFTs of the pixel units of the corresponding group through the first control lines or the second control lines.

14. The driving method as recited in claim 13, wherein the OLED display device further comprises n third control lines, which are disposed corresponding to the groups and electrically connected with the pixel units of the corresponding groups.

15. The driving method as recited in claim 14, wherein before the compensation driving circuit, through one of the scan lines, enables the pixel units of the corresponding row, further comprising a step of:
driving the corresponding pixel units through the third control lines by the compensation driving circuit.
